(19) United States
(12) Patent Application Publication
(10) Pub. No.: US 2018/0283014 A1
(43) Pub. Date: Oct. 4, 2018

(54) RIGID COMPOSITE BOARD FLOOR COVERINGS

(71) Applicant: Columbia Insurance Company, Omaha, NE (US)

(72) Inventors: Clark Hodgkins, Ringgold, GA (US); Jean Briere, Ooltewah, TN (US); Jay Vecsey, Canton, GA (US); Jason Harwood, Chattanooga, TN (US)

(21) Appl. No.: 15/944,351

(22) Filed: Apr. 3, 2018

Related U.S. Application Data
(60) Provisional application No. 62/480,788, filed on Apr. 3, 2017.
(60) Provisional application No. 62/546,742, filed on Aug. 17, 2017.

(51) Int. Cl. E04F 15/10; B32B 21/14; B32B 27/30; B32B 27/20; B32B 3/26; B32B 27/32; B32B 27/16; B32B 27/36; B32B 3/30; E04F 15/04; B32B 37/12

(52) U.S. Cl. CPC E04F 15/107; E04F 15/0215; B32B 27/30; B32B 27/20; B32B 27/304; B32B 3/26; B32B 27/306; B32B 27/32; B32B 27/16; B32B 27/36; B32B 3/30; E04F 15/041; B32B 37/12; B32B 2266/0278; B32B 2255/00; B32B 2323/04; B32B 2327/06; B32B 2331/04; B32B 2367/00; B32B 2419/00; B32B 21/14

(57) ABSTRACT

Disclosed are rigid composite board floor coverings and methods of making same. Also disclosed are rigid composite board floor covering installations and methods of making same.

### CROSS REFERENCE TO RELATED APPLICATIONS

This application claims the benefit of priority to copending U.S. provisional patent application No. 62/480,788, filed Apr. 3, 2017, and to copending U.S. provisional patent application No. 62/546,742, filed Aug. 17, 2017. The entire disclosure of each of the aforementioned patent applications is incorporated by reference herein.

### FIELD OF THE INVENTION

The present invention relates generally to rigid composite floor coverings. More specifically, the present invention relates to improved rigid composite floor coverings that can in one aspect be directly glued to a subfloor in the absence of any side edge locking structure. Also provided are methods for making a rigid composite floor covering and methods of forming a rigid composite floor covering installations are disclosed herein.

### BACKGROUND OF THE INVENTION

Resilient flooring has been a popular floor covering material for many years. Resilient flooring is typically available in either tile or sheet form for both commercial and residential use. As finished flooring material, vinyl tile has been used extensively in commercial, institutional and public building applications, such as, for example, malls, schools, healthcare facilities, convention and exposition centers, civic buildings, private office buildings, sports facilities, and so forth. Resilient flooring has been produced from both vinyl and nonvinyl materials.

To provide additional acoustical properties to such resilient floor coverings, resilient flooring is often installed over a separate acoustical base layer such as rubber or cork underlayment material. The acoustical layer can serve one or more of a variety of different functions in a given installation. In some installations, the function of the underlayment material is to provide a cushioning effect to the floor system. It is known that, due to its the pliable nature, resilient flooring presents concerns of telegraphing irregularities, ripples, and waves that may be present on uneven subfloor structures. Thus, in other situations, the function of the underlayment material is to compensate for irregularities in the surface of the underlying subfloor, which can be concrete, plywood, or a number of other different materials that are commonly used and known. Another function of the underlayment, which is particularly pertinent to the present invention, is to reduce the transmission of sound through the floor to a room below in a multi-floor building. This is particularly significant where the maximum allowable level of sound transmission is controlled by local building codes, which is increasingly common. In such cases, the acoustical base layer may be adhered to the sub-floor, and the resilient tiles may be installed over the acoustical base layer, again using an adhesive.

An alternative to resilient flooring has also been developed utilizing a more rigid plank technology. This is also referred to in the art as rigid composite board (RCB) flooring. In certain installations, rigid composite board technology can provide additional advantages not satisfied by conventional resilient floor coverings. For example, a rigid composite board can be installed over existing hard surfaces, eliminating the concerns of telegraphing thanks to its rigid plank technology that eliminates ripples and waves caused by uneven subfloors. A rigid composite board can also be milled to incorporate interlocking edge profiles such as a tongue and groove or click lock type system. There are, however, several disadvantages associated with such rigid composite board flooring systems. For example, rigid composite board flooring is known to have variable stability and can thus require acclimation periods prior to installation in order to allow stresses to equalize prior to any installation. Thus, conventionally, acoustical padding layers if desired are installed as an underlayment during the installation process. Additionally, due to their varying stability conventional rigid composite board floors are manufactured to be installed as a floating floor rather than a direct glue installation.

Thus, there is a need for improved rigid composite flooring having improved long term stability as compared to conventional systems. The improved rigid composite flooring can provide desired resilience and stability such that acclimation periods are not necessary prior to installation. Further, the improved rigid composite flooring can be directly glued in place without the need for any interlocking mechanical fastening edge profiles such as a conventional tongue and groove or click lock type system. Still further, the rigid composite can have an attached acoustical pad or underlayment integrated into the flooring so a separate underlayment is not required during installation. These and a number of additional features are provided by the following disclosure.

### SUMMARY

The present invention is generally directed to rigid composite floor coverings. In one aspect, a rigid composite board is provided comprising a rigid composite core layer having a top surface and an opposed bottom surface and a plurality of side edges extending between the opposed top and bottom surfaces. The plurality of side edges are not profiled to define any form of a side edge locking structure by which adjacent floor covering boards can be attached to one another. A decorative portion having a top surface and an opposing bottom surface overlies the rigid composite core layer such that the top surface of the rigid composite core layer contacts the bottom surface of the decorative layer portion. A padded backing layer portion having a top surface and an opposed bottom surface is attached to the bottom surface of the rigid composite core layer such that the bottom surface of the padded backing layer portion is configured to abut a subfloor structure when the rigid composite floor covering is placed in a selected orientation. The rigid composite core layer at least substantially prevents telegraphing of hard surface subfloor structure irregularities, such as ripples and waves, to the decorative layer portion when the rigid composite floor covering is abutting the subfloor structure in the selected orientation.

In a further aspect, disclosed is a rigid composite floor covering installation. The disclosed installation comprises a plurality of adjacent composite boards overlying a subfloor structure, wherein each of the plurality of adjacent rigid composite boards comprises a rigid composite core layer having a top surface and an opposed bottom surface and a plurality of side edges extending between the opposed top and bottom surfaces. The plurality of side edges are not profiled to define any form of a side edge locking structure by which adjacent floor covering boards can be attached to one another. A decorative portion having a top surface and an opposing bottom surface overlies the rigid composite core layer such that the top surface of the rigid composite core layer contacts the bottom surface of the decorative layer portion. A padded backing layer portion having a top surface and an opposed bottom surface is attached to the bottom surface of the rigid composite core layer. The bottom surface of each padded backing layer portion of each of the plurality of adjacent rigid composite boards is adhered to the subfloor structure and adjacent rigid composite boards are not connected to one another by any form of a side edge locking structure. The rigid composite core layer of each of the plurality of adjacent rigid composite floor boards at least substantially prevents telegraphing of hard surface subfloor structure irregularities, such as ripples and waves, to the decorative layer portion.

Still further, in another aspect, disclosed is a method of making a rigid composite board floor covering of the present disclosure. The method generally comprises providing a rigid composite core layer of a predetermined size and shape having a top surface and an opposed bottom surface and a plurality of side edges extending between the opposed top and bottom surfaces, wherein the plurality of side edges do not define a side edge locking structure. A decorative portion is applied to the top surface of the rigid composite core layer and a padded backing layer portion is bonded to the bottom surface of the rigid composite core layer. In some aspects, the rigid composite core layer is not cut to a second predetermined size and shape after applying the decorative portion and padded backing layer portion to the respective top and bottom surfaces thereof. In alternative aspects, the rigid composite core layer can be cut to a second predetermined size and shape after applying the decorative portion and padded backing layer portion to the respective top and bottom surfaces thereof. In still further aspects, the method does not comprise an acclimation period after the applying of the decorative layer portion and padded backing layer portion to the rigid composite core layer to equalize component stress prior to an installation.

Still further, in another aspect, disclosed herein is a method of forming a rigid composite board floor covering installation. The method generally comprises providing a plurality of rigid composite boards as described herein, wherein each of the plurality of rigid composite boards comprises a rigid composite core layer having a top surface and an opposed bottom surface and a plurality of side edges extending between the opposed top and bottom surfaces. The plurality of side edges are not profiled to define any form of a side edge locking structure by which adjacent floor covering boards can be attached to one another. A decorative portion having a top surface and an opposing bottom surface overlies the rigid composite core layer such that the top surface of the rigid composite core layer contacts the bottom surface of the decorative layer portion. A padded backing layer portion having a top surface and an opposed bottom surface is attached to the bottom surface of the rigid composite core layer. The bottom surface of each padded backing layer of each provided rigid composite board is adhered to an exposed surface of a subfloor structure to form a selected arrangement of adjacent rigid composite boards. The adjacent rigid composite boards are not connected by any form of an interlocking or other fastening mechanism by which adjacent floor covering boards can be attached to one another.

Additional embodiments of the invention will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE FIGURES

FIG. 1 shows a cross-section schematic view of an exemplary flooring covering comprising a rigid composite board (RCB) core according to one aspect of the present disclosure.

FIG. 2 shows a cross-section schematic view of an exemplary flooring covering comprising a rigid composite board (RCB) core according to one aspect of the present disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

### Definitions

As used herein, the singular forms “a,” “an” and “the” include plural referents unless the context clearly dictates otherwise. Thus, for example, reference to a “surface” includes aspects having two or more such surfaces unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

As disclosed herein, the term “rigid composite board” or “RCB” can be used interchangeable and refers to any composite material comprising a rigid core and capable withstanding heavy duty applications, such as for example, heavy foot traffic, without any significant deformation of the board. The composite material can be any material, including exemplary materials such as plywood, densified fiber, wood and polymer composites (WPC), thermoplastic, thermoset composites, or any combination thereof. Still further, in aspects of the disclosure, a rigid composite board can be defined functionally in that it at least substantially prevents telegraphing of hard surface subfloor structure irregularities, such as ripples and waves, to the decorative layer portion when the rigid composite floor covering is abutting the subfloor structure in the selected orientation.

It is further understood that the RCB comprises a rigid composite core layer. The rigidity of the composite core layer can, for example, be defined by its tensile modulus. It is understood that the rigid composite core layer can exhibit a tensile modulus that exceeds 10⁵ psi (or 689 MPa). The composite core layer is defined as semi-rigid when its tensile modulus falls between 3×10³ and 10⁵ psi (20.7 MPa), and flexible when it has a tensile modulus that is less than 3×10³ psi (or 20.7 MPa) (the tensile modulus values are based on standard ASTM conditions of 23° C. and 50% relative humidity).

The term “fiber” as used herein includes fibers of extreme or indefinite length (i.e. filaments) and fibers of short length (i.e., staple fibers). As used herein, the term “reclaimed fiber” include a fiber reclaimed from a new product, post-industrial product, or post-consumer product. In some exemplary aspect, such products comprise carpets or carpet tiles. As used herein, the term “post-consumer fiber” refers to a fiber that was a part of a product that has been generated by end users of the product which can no longer be used for its intended purpose. The post-consumer fibers include fibers reclaimed from the products that have been used in residential, commercial, and industrial applications, and subsequently have been discarded. As used herein, the term “post-industrial fiber” refers to a fiber reclaimed from a product that is a byproduct of the product manufacturing that has been diverted from the manufacturing waste stream.

As disclosed herein, the term “thermoplastic polymer” refers to a polymer that softens when exposed to heat and returns to its original condition when cooled to room temperature.

As disclosed herein, the term “thermosetting polymer” refers to a polymer that solidifies or sets irreversibly when heated. Thermoset polymers are usually associated with a cross-linking reaction of the molecular constituents induced by heat or radiation.

As used herein, the term “polyester” refers to a category of polymers that contain the ester functional group in their main chain. Polyesters disclosed herein include naturally occurring chemicals, such as in the cutin of plant cuticles, as well as synthetics produced through step-growth polymerization. A non-limiting example of polyesters includes any long-chain synthetic polymer composed of at least 85% by weight of an ester of a substituted aromatic dicarboxylic acid, including but not restricted to substituted terephthalic units, p(—R—O—CO—C₆H₄—CO—O—)ₓ and parasubstituted hydroxy-benzoate units, p(—R—O—CO—C₆H₄—O—)ₓ. In certain examples, the polyesters comprise polyethylene terephthalate (PET) homopolymer and copolymers, polypropylene terephthalate (PPT) homopolymer and copolymers and polybutylene terephthalate (PBT) homopolymer and copolymers, and the like, including those that contain comonomers such as cyclohexanedimethanol, cyclohexanedicarboxylic acid, isophthalic acid, and the like.

The terms “polyamide” as utilized herein, is defined to be any long-chain polymer in which the linking functional groups are amide (—CO—NH—) linkages. The term polyamide is further defined to include copolymers, terpolymers and the like as well as homopolymers and also includes blends of two or more polyamides. In some aspects, the plurality of polyamide fibers comprise one or more of nylon 6, nylon 66, nylon 10, nylon 612, nylon 12, nylon 11, or any combination thereof. In other aspects, the plurality of polyamide fibers comprises nylon 6 or nylon 66. In yet other aspect, the plurality of polyamide fibers is nylon 6. In a yet further aspect, the plurality of polyamide fibers is nylon 66.

As defined herein, the term “polyolefin” refers to any class of polymers produced from a simple olefin (also called an alkene with the general formula CₙH₂ₙ) as a monomer. In some aspects, the polyolefins include, but are not limited to, polyethylene, polypropylene, both homopolymer and copolymers, poly(I-butene), poly(3-methyl-1-butene), poly(4-methyl-1-pentene) and the like, as well as combinations or mixtures of two or more of the foregoing.

As defined herein, the term “polyurethane” refers to any class of polymers composed of a chain of organic units joined by carbamate (urethane, R₁—O—CO—NR₂—R₃, wherein R1, R2 and R3 are the same or different) links.

As defined herein, the term “polystyrene” refers to any class of synthetic polymers produced from a simple styrene as a monomer. It is understood that the term “polystyrene” includes both atactic and syndiotactic polystyrenes. In some specific aspects, described are also co-polystyrenes including a high-impact polystyrenes (HIPS), acrylonitrile butadiene styrene (ABS) or copolymer of styrene with acrylonitrile (SAN), or copolymer of styrene with maleic acid (SMA).

As defined herein, the terms “polyvinyl chloride” or “PVC” can be used interchangeably and refer to a polymer produced by polymerization of vinyl chloride monomer. It is understood that PVC can be made ductile or elastic depending on specific additives added during polymerization process.

As used herein, the term “acclimation period” refers to a period of time required for one or more components in the rigid composite board floor covering to adjust or condition to equalize differing stresses that may be present in the various components. In some aspects, the lack of an “acclimation period” can refer to the lack of an acclimation period associated with assembly of the various component parts during manufacture of the rigid composite board of the present disclosure. In other aspects, the lack of an acclimation period can refer to the lack of any needed acclimation period of the composite board floor covering at a site of installation.

Impact Insulation Class rating or IIC rating is determined in accordance with ASTM E989-06, entitled “Standard Classification for Determination of Impact Insulation Class (IIC).” This classification rating can be used by architects, builders and code authorities for acoustical design purposes in building construction. The greater the IIC rating, the lower the impact sound transmission through the floor-ceiling assembly.

As used herein, the term “providing,” when used in the context of a method step does not inherently and specifically require that actual steps required to manufacture the item, composition, or component stated to be provided. Rather, this intended as a generic step that can include manufacturing of the specific item, composition, or component, as well as otherwise receiving or obtaining the provided item, composition, or component from other sources. Thus, it should be understood that the term “providing” should not be construed narrowly to necessarily require an actual manufacturing of the provided item, composition, or component.

As used herein, the term side edge locking mechanism or structure refers to a profiled edge the forms a locking connection between two adjacent panels such that the two adjacent panels are affixed in a manner that prevents relative lateral or horizontal separation between the two panels. In some aspects, a side edge locking structure can be an interlocking structure or mechanism as described herein. A conventional click lock mechanism is an example of a side edge locking structure. In contrast, it should be understood that conventional tongue and groove profiles that only restrict vertical movement of adjacent panels is not to be considered a side edge locking structure as the tongue and groove profile does not restrict lateral or horizontal displacement. It should therefore be understood that as used herein, aspects that specifically disclaim a side edge locking structure still include (do not exclude) aspects where, for example, the side edge simply abuts another a side edge in view of having no special profile and also include aspects having conventional tongue and groove profiles.

As used herein, the terms “interlocking mechanism” or “interlocking structure” refer to locking means which lock adjacent floor covering boards together in manner which restricts or prevents at least a horizontal separation of two adjacent interlocked board. This can also include aspects that prevent both a horizontal or lateral separation and relative vertical displacement. Some exemplary interlocking mechanisms contain both a tongue type protrusion and a groove like profile within the same flooring covering board, such as, for example, a click lock type profile. For example, the tongue type profile can be machined into one side and one end of the board with the groove like profile being machined into the opposite side and end of the same panel. Such joints can be made by machining the edges of the boards. Alternatively, parts of the interlocking mechanism can be made of a separate material which is then integrated with the floor covering board. It is understood that the term “interlocking mechanism” is not construed to be limited to only profiles or feature that are integral to the floor covering boards. Other exemplary interlocking mechanisms include snapping connections incorporated into the board edges, angling board with interlocking edges, boards with overlapping edges, boards with the puzzle-lock edges, boards with slopping edges etc. It is understood that the term “interlocking mechanism” allows a plurality of panels to be readily joined in interlocking relationship such that when assembled, there is no necessity for separate structural frames.

Besides the locking means provided by the floor covering boards, the interlocking mechanism, as defined herein, can further include locking elements. In some examples, such locking elements can include strips with salient features that engage the locking element onto two adjacent flooring panels. Such locking devices can be made of the same material as a floor covering panel, aluminum, wood fiber, etc.

The present invention may be understood more readily by reference to the following detailed description of preferred embodiments of the invention and the examples included therein and to the Figures and their previous and following description.

### Rigid Composite Board Floor Covering

As summarized above, the disclosed rigid composite board floor coverings generally comprise a rigid composite core layer having a top surface and an opposed bottom surface and a plurality of side edges extending between the opposed top and bottom surfaces. The plurality of side edges are not profiled to define any form of an interlocking or other fastening mechanism by which adjacent floor covering boards can be attached to one another. A decorative layer portion having a top surface and an opposing bottom surface overlies the rigid composite core layer such that the top surface of the rigid composite core layer contacts the bottom surface of the decorative layer portion. A padded backing layer portion having a top surface and an opposed bottom surface is attached to the bottom surface of the rigid composite core layer such that the bottom surface of the padded backing layer portion is configured to abut a subfloor structure when the rigid composite floor covering is placed in a selected orientation. The rigid composite core layer at least substantially prevents telegraphing of hard surface subfloor structure irregularities, such as ripples and waves, to the decorative layer portion when the rigid composite floor covering is abutting the subfloor structure in the selected orientation.

### Rigid Composite Core

As disclosed herein and summarized above, the rigid composite board floor covering comprises a rigid composite core layer having a top surface and an opposed bottom surface and a plurality of side edges extending between the opposed top and bottom surfaces. The plurality of side edges are not profiled to define any form of an interlocking or other fastening mechanism by which adjacent floor covering boards can be attached to one another. In some aspects, the rigid composite core layer can comprise any composite materials that provides a desirable rigidity and which does not necessitate a need for an acclimation period during manufacturing process. In some exemplary aspects, the rigid composite core layer can be made of plastic, rubber, wood and plastic composite, wood or a fiber based material such as solid wood, HDF or MDF for example.

In other aspects, the rigid composite board floor covering can comprise a first and a second rigid composite core layer, each having a top surface and an opposed bottom surface and a plurality of side edges extending between the opposed top and bottom surfaces. In these aspects, the plurality of side edges are also not profiled to define any form of an interlocking or other fastening mechanism by which adjacent floor covering boards can be attached to one another.

In some aspects, the rigid composite core layer can comprise a high density fiberboard (HDF) or a medium density fiberboard (MDF). In these aspects, both HDF and MDF are engineered wood products. In some aspects, the HDF core layer can be prepared from wood fiber extracted from chips and pulped wood waste. In certain aspects, the HDF has a density greater than 50 lb/ft³, including exemplary values of greater than 60 lb/ft³, 70 lb/ft³, 80 lb/ft³, 90 lb/ft³, or greater than 100 lb/ft³. In certain aspects, to improve water resilience of the HDF based core layer, processing oils can be added during the board formation under high temperature and pressure.

In other aspects, the MDF can be prepared from wood wastage fibers glued together with resin or glued under heat and pressure. In certain aspects, the MDF has a density of 30 to 50 lb/ft³, including exemplary values of 35 lb/ft³, 40 lb/ft³, and 45 lb/ft³.

In certain aspects, the rigid composite core layer can comprise a densified fiber batt. In some aspects, the densified fiber batt has a density of from about 5 lb/ft³ to about 100 lb/ft³, including exemplary densities of 10, 15, 20, 25, 30, 35, 40, 45, 50, 55, 60, 65, 70, 75, 80, 85, 90, and 95 lb/ft³. In still further aspects, the volumetric density can be a value within any range derived from the above values, including for example, a density of from about 15 to about 75 lb/ft³. Still further, in certain aspects, the rigid composite core layer can comprise one or more densified fiber batts. It is further understood that if more than one densified fiber batt are present in the core layer, each of the densified fiber batts can exhibit density that can be same or different from another densified batt.

In still further aspects, the rigid composite core layer comprising one or more densified fiber batts can exhibit different density across the rigid composite core layer. For example, the rigid composite layer can have a first portion having a first density and a second portion having a second density different from the first density. In some aspects, the first portion of the rigid composite layer is adjacent to the top surface of the rigid composite core layer. In other aspects, the second portion of the rigid backing portion is adjacent to the bottom surface of the rigid composite core layer. In certain aspects, the first density is larger than the second density. In still other aspects, the first density is lower than the second density.

In some aspects, wherein the one or more densified fiber batts are present in the rigid composite core layer, such densified fiber batts can comprise a first plurality of oriented fibers having a first melting point and a second plurality of oriented fibers having a second melting point different from the first melting point. It is understood that in certain aspects, the first and second plurality of oriented fibers can have a substantially random, uniform, or predetermined orientation, or a combination of various orientations.

In certain aspects, the first and second plurality of oriented fibers, each independently can comprise a staple fiber, a bulk continuous fiber (BCF), or a combination thereof. In yet other aspects, at least one of the first and second pluralities of oriented fibers can comprise reclaimed fibers. In yet other aspects, at least one of the first and second pluralities of oriented fibers can comprise a post-consumer or post-industrial fiber.

In other aspects, the first and second plurality of oriented fibers, each independently can comprise polyester, polypropylene, polyethylene, polyamides, polyurethane, polylactic acid, acetal, co-polyester, co-polyamide, polystyrene, or a combination thereof.

Exemplary fibers present in the first and/or second plurality of oriented fibers can include polyamides, polyester, polypropylene, polyethylene, polyurethane, polyethylene terephthalate, polytrimethylene terephthalate, latex, styrene butadiene rubber, or any combination thereof. In yet other aspects, at least one of the first and second pluralities of fibers can comprise a multi-component fiber. It is understood that in some aspects of the present invention, the multi-component fibers can be defined as “extruding two polymers from the same spinneret with both polymers contained within the same filament.” In some aspects, multi-component fibers can have any cross sectional shape or geometry that can be contemplated by one of ordinary skill in the art. In some aspects, the multi-component fibers can have cross-section structures that include but are not limited to side-by-side fiber, sheath-core fiber, islands-in-the-sea fiber and segmented-pie cross-section types.

In some aspects, the rigid composite core layer can comprise a composite material formed from raw or unprocessed bamboo dust, wood dust, cork dust or a mixture thereof and a polymer. In some aspects, the rigid composite core layer can comprise a composite material formed from raw or unprocessed bamboo dust, wood dust, cork dust or a mixture thereof and high density polyethylene (HDPE) or alternatively, virgin or recycled PVC. In other aspects, the polymer can be a combination of such virgin and recycled PVCs. In still further aspects, such rigid composite material can comprise up to about 10% chemical additives such as anti-UV agents, anti-oxidation agents, stabilizers, colorants, anti-fungus agents, coupling agents, reinforcing agents, and lubricants. In yet other aspects, such rigid composite material does not comprise anti-UV agents, anti-fungals, and insecticides.

In yet other aspects, the rigid composite core layer can comprise various thermoplastic materials. In some aspects, the thermoplastic material is a polyolefin including polyethylene or polypropylene, and rigid polyvinyl chloride (PVC). In yet other aspects, semi-rigid or flexible polyvinyl chloride can also be used. In certain aspects, the olefins or the rigid PVC possesses good impact strength, ease of processing, high extrusion rate, good surface properties, excellent dimensional stability, and indentation resistance. In certain aspects, the flexibility of the thermoplastic material can be imparted by using at least one liquid or solid plasticizer. In certain aspects, the plasticizer can be present in an amount of less than about 20 phr, or, less than 1 phr (e.g., less than 20% by weight of the core), especially in the case of PVC.

It should be understood that any rigid polyvinyl chloride resin can be used. Polyvinyl chloride polymers useful according to the invention include those described in “Vinyl Chloride Polymers” entry of Kirk-Othmer Encyclopedia of Chemical Technology, Vol. 24, 4th ed., (1997) pp. 1017-1053, which is incorporated herein by reference. In exemplary aspects, vinyl chloride resins such as homopolymers of vinyl chloride, copolymers of vinyl chloride and other vinyl monomers, halogenated compounds of their homopolymers, and alloys or blends with other plastics suitably can be utilized. By further example, weatherable polyvinyl chloride (PVC) such Duracap® and Geon® (commercially available from PolyOne) may be used in the rigid polyolefin core layer.

In other aspects, PVC polymers useful according to the invention can include homopolymers of vinyl chloride and those vinyl chloride polymer resins having at least 70 wt. % repeating units polymerized from a vinyl chloride monomer, or at least 80 wt. %, or at least 90 wt. %, or even 95 wt. % or more of repeating units polymerized from a vinyl chloride monomer.

The polyvinyl chloride compositions of the invention may comprise repeating units polymerized from a vinyl chloride monomer, and may also include comonomers up to 30 weight percent of the copolymer from, without limitation, one or more of: the esters of acrylic acid, for example, methyl acrylate, ethyl acrylate, butyl acrylate, octyl acrylate, cyanoethyl acrylate, and the like; vinyl esters such as vinyl acetate and vinyl propionate; esters of methacrylic acid, such as methyl methacrylate, ethyl methacrylate, hydroxyethyl acrylate, butyl methacrylate, and the like; nitriles, such as acrylonitrile and methacrylonitrile; acrylamides, such as methyl acrylamide, N-methylol acrylamide, N-butoxy methacrylamide, and the like; halogen containing vinyl monomers such as vinylidene chloride, vinylidene fluoride, and vinyl bromide; vinyl ethers such as ethylvinyl ether, chloroethyl vinyl ether and the like; the vinyl ketones, styrene derivatives including α-methyl styrene, vinyl toluene, chlorostyrene; vinyl naphthalene; olefins such as ethylene, butene, isobutylene, propylene and hexene; and other copolymerizable monomers or mixtures of monomers having suitable reactivity ratios with vinyl chloride and known to those skilled in the art.

In certain aspects, PVC blends can be used. In such aspects, the crosslinked PVC can be blended with non-crosslinked PVC. In yet other aspects, a crosslinked PVC alone can be utilized. It is understood that crosslinked PVC polymers can be made by polymerizing vinyl chloride in the presence of cross-linking monomers such as the aforementioned diallyl phthalate, trimethylol propane triacrylate, allyl methacrylate, and the like.

It is further understood that in the aspects, wherein the rigid composite core layer comprises PVC composition, these compositions are unmodified or unplasticized PVC that can contain small amounts or no plasticizer. Also, according to the present invention rigid PVC refers to the property of a given compound having a certain tensile modulus. Therefore, rigid PVC according to the present invention can have tensile modulus values that vary over a wide range, for example, the tensile modulus values may be from about 800 MPa to about 1000 MPa, or from about 1000 MPa up to about 2000 MPa or even up to 3000 MPa or greater.

In yet other aspects, the rigid composite core layer of the current disclosure can further comprise a filler. Exemplary and non-limiting fillers can include calcium carbonate, fly-ash, recycled calcium carbonate, aluminum trihydrate, talc, nano-clay, barium sulfate, barite, barite glass fiber, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, and any combination thereof. In some aspects, the filler content can be virgin. In other aspects, the filler content can be reclaimed. In certain aspects, the filler content can be reclaimed from post-consumer articles. In yet other aspects, the filler content can be reclaimed from post-industrial articles.

In certain aspects, the filler comprises one or more of calcium carbonate, aluminum trihydrate, barite, feldspar, cullet, fly ash, kaolin clay, limestone, polyurethane foam, rubber, thermoplastic powder, thermoplastic polyurethane (TPU), wollastonite, or any combination thereof.

In yet other aspects, the rigid composite core layer can further comprise a pigment, a flame retardant, surfactant, processing aids, or a combination thereof. In certain aspects, the rigid composite core layer can comprise one or more flame retardant components. Exemplary flame retardants that can be incorporated into the rigid composite core layer include, without limitation, organo-phosphorous flame retardants, red phosphorous magnesium hydroxide, magnesium dihydroxide, hexabromocyclododecane, bromine containing flame retardants, brominated aromatic flame retardants, melamine cyanurate, melamine polyphosphate, melamine borate, methylol and its derivatives, silicon dioxide, calcium carbonate, resourcinol bis-(diphenyl phosphate), brominated latex base, antimony trioxide, strontium borate, strontium phosphate, monomeric N-alkoxy hindered amine (NOR HAS), triazine and its derivatives, high aspect ratio talc, phosphated esters, organically modified nanoclays and nanotubes, non-organically modified nanoclays and nanotubes, ammonium polyphosphate, polyphosphoric acid, ammonium salt, friaryl phosphates, isopropylated triphenyl phosphate, phosphate esters, magnesium hydroxide, zinc borate, bentonite (alkaline activated nanoclay and nanotubes), organoclays, aluminum trihydrate (ATH), azodicarbonamide, diazenedicarboxamide, azodicarbonic acid diamide (ADC), friaryl phosphates, isopropylated triphenyl phosphate, triazine derivatives, alkaline activated organoclay and aluminum oxide. Any desired amount of flame retardant can be used in the rigid composite core layer and the selection of such amount will depend on a required application. Such amounts can be readily determined through no more than routine experimentation.

In other aspects, any pigments or surfactant known in the art can be utilized. In yet other aspects, any processing aids known in the art can be used. In some aspects, processing aids can include without limitation antistatic chemicals, lubricants, oils, or any combination thereof.

In yet other aspects, the rigid composite core layer comprises any of polyvinyl chloride polymers described herein, a calcium carbonate as a filler and a stabilizer.

In yet other aspects, the rigid composite core layer can have a thickness in the range from about 1.5 mm to about 12 mm, including exemplary values of about 2 mm, about 3 mm, about 4 mm, about 5 mm, about 6 mm, about 7 mm, about 8 mm, about 9 mm, about 10 mm, and about 11 mm. In still further aspects, the rigid composite core layer can have a thickness in any range between two foregoing values. In some aspects, the thickness can be in the range from about 1.5 mm to about 12 mm.

In yet other aspects, the rigid composite core layer can have a width in the range from about 3 inch to about 50 inch, including exemplary values of about 5 inch, about 8 inch, about 10 inch, about 13 inch, about 15 inch, about 18 inch, about 20 inch, about 23 inch, about 25 inch, about 28 inch, about 30 inch, about 33 inch, about 35 inch, about 35 inch, about 38 inch, about 40 inch, about 43 inch, about 45 inch, about 48 inch. In still further aspects, the rigid composite core layer can have a width in any range between two foregoing values. In some aspects, the thickness can be in the range from about 3 inch to about 48 inch.

In yet other aspects, the rigid composite core layer can have a length in the range from about 12 inch to about 100 inch, including exemplary values of about 15 inch, about 20 inch, about 25 inch, about 30 inch, about 35 inch, about 40 inch, about 45 inch, about 50 inch, about 55 inch, about 60 inch, about 65 inch, about 70 inch, about 75 inch, about 80 inch, about 85 inch, about 90 inch, and about 96 inch. In still further aspects, the rigid composite core layer can have a length in any range between two foregoing values. In some aspects, the thickness can be in the range from about 12 inch to about 96 inch.

It is understood that in the aspects where the first and the second rigid composite core layers are present, each of the layers can be any layer described above. It is further understood that in the aspects where the first and the second rigid composite core layers are present, the first and the second rigid composite core layer can be the same or different. In some aspects, the first and the second rigid composite core layers can be prepared from the same or different materials, have the same or different size, thickness, or density.

### Decorative Layer

The rigid composite board floor coverings of the present disclosure further comprise a decorative portion. In one aspect, the decorative portion can be a separate decorative layer applied to the top surface of the rigid composite core layer. According to these aspects, the decorative layer portion has a top surface and an opposing bottom surface and overlies the rigid composite core layer such that the top surface of the rigid composite core layer contacts the bottom surface of the decorative layer portion. In certain aspects, the decorative layer portion can comprise one or more layers. In some aspects, the decorative layer portion is a laminated decorative layer. In yet other aspects, the decorative layer portion is glued or attached to the rigid composite core layer via heat, pressure, cold or hot press, or any other known in the art method.

In other aspects, the decorative layer portion can comprise polyvinyl chloride (PVC), whitened PVC, opaque PVC, oriented polypropylene (OPP), polyolefin (PO), woven polyethylene (PE), nonwoven PE, woven polypropylene (PP), nonwoven PP, woven PET, nonwoven PET, woven nylon, nonwoven nylon, conventional papers, conventional foils, or foiled oriented polypropylene. In yet other aspects, the decorative layer portion can comprise a vinyl layer. In yet other aspects, the decorative layer portion comprises luxury vinyl tile. (LVT).

In some aspects, the decorative layer portion comprises an image substrate layer having an image printed on a surface thereof. In some aspects, the image substrate layer comprises at least one of polyvinyl chloride (PVC), whitened PVC, opaque PVC, oriented polypropylene (OPP), polyolefin (PO), woven polyethylene (PE), nonwoven PE, woven polypropylene (PP), nonwoven PP, woven PET, nonwoven PET, woven nylon, nonwoven nylon, conventional papers, conventional foils, or foiled oriented polypropylene.

In yet further aspects, the decorative layer portion can further comprise a printed film layer and a wear layer. The print layer can, for example, be a digitally printed, or a photo gravure printed layer. In yet other aspects, the wear layer can be adhered to a printed film layer. In one aspect, the wear layer can comprise, for example and without limitation, conventional ionomers, polyethylene terephthalate (PET), polyurethane, polypropylene, polytrimethylene terephthalate (PTT), nylon 6, nylon 6,6, polyvinyl chloride (PVC), and the like. In a further aspect, the wear layer can comprise surlyn resin, such as, for example and without limitation, Surlyn® 1706 resin, manufactured by E.I. du Pont de Nemours and Company, Inc.

In a still further aspect, the wear layer can comprise heat stabilized biaxially-oriented PET (BoPET), amorphous PET (aPET), recycled PET (rPET), polyethylene terephthalate glycol-modified (PETG), polyolefin, cyclic olefin copolymer (COC), cyclic olefin polymer (COP), polyvinylidene fluoride (PVDF), polylactic acid (PLA) copolymers, nylon, cellulose acetate, poly(methyl methacrylate) (PMMA), thermoplastic polyurethane (TPU), thermoplastic elastomers (TPE), polycarbonate, polyethylene (PE), high density polyethylene (HDPE), low density polyethylene (LDPE), or a copolymer thereof.

In some aspects, the wear layer is substantially transparent. In other aspects, the wear layer is substantially opaque. In a yet further aspect, the wear layer can have a thickness in the range of from about 4 mil to about 30 mil, including exemplary thickness ranges of from about 4 to about 8 mil, about 9 to about 14 mil, or about 16 to about 30 mil. In a still further aspect, the thickness of the wear layer can be in a range derived from any of the above listed exemplary values. For example, the thickness can in the range of about 4 mil to about 9 mil, or from 4 mil to about 16 mil.

In certain aspects, the top surface of the decorative layer portion is embossed. It is understood that in the aspects, where the wear layer is present, the top layer of the decorative layer portion is the wear layer. In the aspects, where the wear layer is absent, but the decorative layer portion comprises an image substrate layer having an image printed on a surface thereof, the image surface is the top layer of the decorative layer portion. The embossing can be done to provide visuals and textures to duplicate wood grain, slate and other visuals commonly seen in floor covering. Laser etching can also be utilized in lieu of embossing to achieve the desired aesthetics. Some other potential methods for texturing the surface of wall board, flooring materials or roofing products include drag wiring while the temperature of an extruded product is still above glass transition temperature or dragging probes across the surface while the product or probe is moving. Further, a texture can be embedded in the surface of an injection mold, compression mold or vacuum form mold, as well. A texture can also be hot or cold stamped with pressure for creating the desired look.

In certain aspects, the decorative layer portion can comprise an ink layer. In still further aspects, the ink layer has a top surface and a bottom surface, and wherein the bottom surface of the ink layer is opposed to the top surface of the ink layer. In still further aspects, at least a portion of the top surface of the ink layer defines at least a portion of the top surface of the decorative layer portion. Optionally, the ink layer can also define the bottom surface of the decorative layer portion. For example, the ink layer can be applied to an underlying substrate. The underlying substrate can be a dedicated decorative portion layer such as paper layer intended specifically as a substrate for application of the ink layer. Alternatively, the underlying substrate can be the top surface of the rigid composite core layer such that the ink layer is directly applied to the rigid composite core.

In certain aspects, it is contemplated that the ink layer can be applied either directly or indirectly thereto the top surface of the underlying substrate. In a further aspect, the ink layer can comprise any conventional ink, dye, pigment, or other marking substance that can be applied within the resilient floor covering in a desired pattern. For example and without limitation, the ink layer can comprise water-based, soy-based, a UV-cured inks, and/or solvent-based pigments. In still further aspect, the ink layer is a UV cured ink.

It is understood that UV-cured inks can comprise photo-initiators, pigments, additives, monomers and oligomers of various polymers, and the like. In some exemplary aspects, the UV-cured inks can comprise, without limitation, (5-ethyl-1,3-dioxan-5yl)methyl acrylate, 2-phenoxyethyl acrylate; 1-vinylhexahydro-2H-azepin-2-one, substituted phosphine oxide, thrimethylolpropane triacrylate, phenyl bis (2,4 6-trimethylbenzoyl)phosphine oxide, epoxy acrylate oligomer, diacrylate monomer, multi-functional monomers, amine modified acrylate oligomer, 1-vinylhexahydro-2H-asepin-2-one, diacrylate oligomers, benzophenone, triacryalte monomers, 1-hydroxy-cyclohexylphenyl-ketone, 2 hydroxy-2-methylpropiophenone, and the like.

In a further aspect, the ink layer can be applied to the substrate layer by any conventional printing means, which can include, without limitation, rotogravure printing, flexography printing, lithography printing, offset-lithography printing, relief printing, thermography printing, thermal sublimation printing, dye-sublimation printing, heat-transfer printing, digital printing, and the like.

In still further aspects, the ink layer applied by a digital printing. In an exemplary aspect, the ink layer can comprise inks and pigments manufactured by Collins Inks, INX Inks, Durst, HP, EFI, Sun Chemical, or Tiger. In yet other aspects, the ink layer can be digitally printed utilizing digital printers manufactured by Cefla, Durst, Hymmen, EFI, Barbaran or Inca.

In certain aspects, the formed ink layer can be a continuous layer that covers substantially all of the top surface of the substrate. In yet other aspects, the formed ink layer can be a discontinuous layer that covers only a portion of the top surface of the substrate. In yet other aspects, the ink layer can have any desired aesthetic appearance, such as, for example and without limitation, the appearance of simulated hardwood or ceramic flooring.

In aspects where the ink substrate layer is a separate and distinct layer from the top surface of the rigid composite core, the substrate layer can comprise a transparent PVC material. In yet other aspects, this ink substrate layer can comprise a whitened PVC. In still further aspects, the ink substrate layer can comprise an opaque PVC. It is understood that if whitened substrate is used, any whitening agent known in the art can be utilized. It is further understood that the whitening agent disclosed herein can comprise inorganic and/or organic compounds. In yet other aspects, the whitening agent can be a fluorescent whitening agent. In some exemplary aspects, the whitening chemistry comprises titanium dioxide, zinc dioxide, and the like. In some other aspects, the whitening can be also achieved by cavitation.

In further aspects, the ink substrate layer can comprise one or more of a heat stabilized biaxially-oriented PET (BoPET), amorphous PET (aPET), recycled PET (rPET), polyethylene terephthlate glycol-modified (PETG), polyolefin, cyclic olefin copolymer (COC), cyclic olefin polymer (COP), polyvinylidene fluoride (PVDF), polylactic acid (PLA) copolymers, nylon, cellulose acetate, poly(methyl methacrylate) (PMMA), thermoplastic polyurethane (TPU), thermoplastic elastomers (TPS), polycarbonate, polyethylene (PE), or a copolymer thereof.

In certain aspects, the ink substrate layer has a thickness from about 1 mil to about 10 mil, including exemplary values of about 2 mil, about 3 mil, about 4 mil, about 5 mil, about 6 mil, about 7 mil, about 8 mil, and about 9 mil. In still further aspects, the substrate layer can have any thickness in a range derived from any two of the above listed exemplary values. For example, the substrate layer can comprise a thickness in a range of from about 1 mil to about 5 mil, or from about 3 mil to about 7 mil. In still further aspects, the ink substrate layer can be a film.

The decorative layer portion can have any suitable weight and thickness. In some embodiments, the decorative layer portion has a weight of from about 0.2 ounces per square yard to about 1.0 ounce per square yard, including, without limitation, decorative layer portions having a weight of about 0.3, 0.4, 0.5, 0.6, 0.7, 0.8, and 0.9 ounces per square yard. In a further aspect, a decorative layer portion can have a total thickness of from about 1 mil to about 10 mil, including exemplary values of about 2 mil, about 3 mil, about 4 mil, about 5 mil, about 6 mil, about 7 mil, about 8 mil, and about 9 mil, although virtually any thickness can be used.

### Padded Backing Layer

The disclosed rigid composite board floor coverings further comprise a padded backing layer portion having a top surface and an opposed bottom surface. This padded backing layer portion is attached to the bottom surface of the rigid composite core layer such that the bottom surface of the padded backing layer portion is configured to abut a subfloor structure when the rigid composite floor covering is placed in a selected orientation.

In some aspects, the padded backing layer portion can comprise a single layer of padding material. Alternatively, the padded backing portion can comprise two or more layers of padding material. In certain aspects, it is contemplated that a last layer of the plurality of the layers can define the bottom surface of the padded backing layer portion. It is further contemplated that a first layer of the plurality of layers can define the top surface of the padded backing layer portion.

Still further, in other aspects, the padded backing layer portion can comprise at least one padded backing layer and at least one layer that does not having padding characteristics. For example, the padded backing layer portion can comprise a padded backing material layer and a separate balancing layer. In these aspects, the balancing layer can be the upper surface portion of the padded backing layer portion such that that balancing layer is disposed between the bottom surface of the rigid composite core layer and the top surface of the padded backing material layer. In some aspects the balancing layer or reinforcement layer can comprise a non-woven or wet-laid fiberglass scrims, as well as woven and non-woven thermoplastic fabrics (e.g. polypropylene, nylon and polyester). In still further aspects, the reinforcement layer or balancing layer comprises a fiberglass. Without wishing to be bound by a particular theory, the reinforcement layer or balancing layer can increase dimensional stability by reducing the chance for shrinkage or growth after installation of the flooring product.

In some aspects, the padded backing layer portion can comprise any padded or cushioning backing composition known in the art that provide desirable padding properties. In some aspects, these compositions can comprise foamed polyester, polyamide, polyvinyl chloride, polyolefin, polyurethane, or any combination thereof. In further aspects the padded backing layer can comprise a cork padding layer. It is further understood, that if a combination of various polymers is present in the backing composition, the relative amount of each polymer in the composition can be any amount known in the art.

In one aspect, the padded backing layer can be formed from a backing composition that can comprise, for example and without limitation, foamed low-density polyethylene (LDPE), linear low-density polyethylene (LLDPE), ethylene methacrylate (EMA), ethylene vinyl acetate (EVA), polyethylene-polypropylene (PE-PP) rubber, conventional thermoplastic elastomers (TPEs), conventional thermoplastic olefins (TPOs), alpha-olefin polyethylene co-polymers, polyethylene terephthalate (PET), ethylene butyl acrylate (EBA), irradiation crosslinked polyethylene (IXP) and the like. In a still further aspect, the backing composition comprises an ethylene-octene copolymer.

In a further aspect, and as disclosed in U.S. patent application Ser. No. 11/963,263 (granted U.S. Pat. No. 7,910,194), which is incorporated in its entirety by reference herein, the backing composition used in the padded backing layer portion can comprise substantially linear ethylene polymers and homogeneously branched linear ethylene polymers (i.e., homogeneously branched ethylene polymers), which offer low solidification temperatures, good adhesion to polypropylene, and low modulus relative to conventional ethylene polymers such as low density polyethylene (LDPE), heterogeneously branched linear low density polyethylene (LLDPE), high density polyethylene (HDPE), and heterogeneously branched ultra-low density polyethylene (ULDPE). Exemplary backing layers formed from the disclosed homogeneously branched ethylene polymers are shown in the figures as first or second backing layers.

In a further aspect, any disclosed herein backing compositions can be used alone or can be blended or mixed with one or more synthetic or natural polymeric materials. For examples, suitable polymers for blending or mixing with homogeneously branched ethylene polymers used in the present invention include, but are not limited to, another homogeneously branched ethylene polymer, low density polyethylene, heterogeneously branched LLDPE, heterogeneously branched ULDPE, medium density polyethylene, high density polyethylene, grafted polyethylene (e.g. a maleic anhydride extrusion grafted heterogeneously branched linear low polyethylene or a maleic anhydride extrusion grafted homogeneously branched ultra-low density polyethylene), ethylene acrylic acid copolymer, ethylene vinyl acetate copolymer, ethylene ethyl acrylate copolymer, polystyrene, polypropylene, polyester, polyurethane, polybutylene, polyamide, polycarbonate, rubbers, ethylene propylene polymers, ethylene styrene polymers, styrene block copolymers, and vulcanates.

In yet other aspects, the padded backing layer portion can comprise a cured or uncured polyurethane foam. For example, and without limitation, the polyurethane foam present in the padded backing layer portion can generally be prepared by admixing a first component, such as a polyisocyanate, with a second component, such as an active hydrogen containing material, wherein a gas is introduced therein or produced in situ to form bubbles which in turn form a reduced density expanded cell-like structure in the polyurethane. The process of introducing the bubbles is known as mechanically blowing or frothing the formulation. The process of forming bubbles in situ is commonly referred as chemically blowing. The greater the amount of gas introduced into a polyurethane formulation, the lower the density of the resultant foam produced therewith. But with polyurethane foams generally and with polyurethane foams used in floor covering applications in particular, reducing foam density can also decrease or reduce other properties of the polyurethane foam which can make it a desirable material for use in floor covering applications.

In still further aspects, the padded backing layer can comprise a non woven material, such as non woven fiber matts or batts. For example, and without limitation, in one aspect the padded backing layer can be a non-woven PET fiber mat.

The foams present in the padded backing layer portion can have any desired density, which will depend on the desired use of the foam. In one aspect, the foam can have a density of from about 2 to about 60 pounds per cubic foot, preferably from about 3 to about 30, more preferably from about 6 to about 18, and even more preferably from about 6 to about 14 pounds per cubic foot. For use in a residential floor covering, an exemplary foam can have a density from about 1 to about 10 pounds per cubic foot, including, for example, 2, 4, 6, or 8 pounds per cubic foot. For use in a commercial floor covering, an exemplary foam can have a density from about 11 to about 20 pounds per cubic foot, including, for example, 12, 14, 16, or 18 pounds per cubic foot. Alternatively, for use as a laminate flooring underlayment, an exemplary foam can have a density from about 15 to about 25 pounds per cubic foot, including, for example, 16, 18, 20, 22, and 24 pounds per cubic foot.

The padded backing layer portion can also have any desired thickness. Exemplary embodiments have thickness of from about 5 mils to about 500 mils, including, without limitation, embodiments having thicknesses of about 10 mils, about 20 mils, about 30 mils, about 40 mils, about 50 mils, about 60 mils, about 70 mils, about 80 mils, 90 mils, 100 mils, 120 mils, 140 mils, 160 mils, 180 mils, 200 mils, 240 mils, 250 mils, 280 mils, 320 mils, 350 mils, 400 mils, and 450 mils.

In some aspects, the padded backing layer can further comprise a natural and synthetic rubber component. In still further aspects, the padded backing layer portion does not comprise a rubber component.

In a further aspect, the backing compositions present in the padded backing layer portion can comprise a filler. As would be recognized by one of ordinary skill in the art, the type of filler used will be selected on the basis of the desired physical properties of the final product. In a still further aspect, exemplary fillers can include, for example and without limitation, calcium carbonate, barium sulfate, barite, glass fiber and powder, metal powder, alumina, hydrated alumina, clay, magnesium carbonate, calcium sulfate, silica or glass, fumed silica, talc, carbon black or graphite, fly ash, cement dust, feldspar, nepheline, magnesium oxide, zinc oxide, aluminum silicate, calcium silicate, titanium dioxide, titanates, wood flour, glass microspheres, chalk, and mixtures thereof. In a yet further aspect, additional fillers that can be used include graphite fiber, silica/glass, wollastonite, crushed glass cullet, kaolin, mica, recycled fines, fiberglass, diatomaceous earth, lime, and mixtures thereof. In an even further aspect, an exemplary filler is fly ash, such as, for example and without limitation, Celceram™ fly ash filler PV20A (a calcium aluminum silicate available from Boral). In a further aspect, these backing compositions can comprise post-industrial carpet and/or post-consumer carpet material. In a still further aspect, the backing composition can comprise composites of post-industrial carpet and/or composites of post-consumer carpet. In some aspects, the glass filler is glass fines or crushed glass cullet. In other aspects, the fly ash is coal fly ash.

In a further aspect, the backing compositions present in the padded backing layer portion of the present invention can optionally comprise one or more additives, for example and without limitation, tackifiers, processing agents, foaming agents, plasticizers, or the like. In a still further aspect, the additive can comprise a hydrocarbon resin. In one aspect, the hydrocarbon resin can be PICCOTAC™ 1115, which is manufactured by Eastman Chemical, and which is a relatively high molecular weight, aliphatic C5 resin derived from dienes and other reactive olefin.

In a further aspect, these backing compositions can optionally include maleic anhydride grafts wherein maleic anhydride is grafted onto an ethylene polymer at a concentration of about 0.1 to about 5.0 weight percent, preferably about 1 to about 2 weight percent. In a still further aspect, an exemplary composition for forming a maleic anhydride graft is Amplify® GR 204 resin available from Dow Chemicals.

In aspects where the polyurethane foams are present in the padded backing layer portion, these polyurethane foams can also include fillers at any desired level. For example, the amount of filler can be determined relative to parts polyol. To that end, an exemplary polyurethane can have from about 80 parts per hundred parts of polyol to about 250 parts per hundred parts of polyol, including, without limitation, 90, 100, 120, 130, 150, 160, 190, 200, 220, and 140 parts per hundred parts of polyol. Alternatively, the amount of filler can be determined relative to any other desired component of the polyurethane composition, or even relative to the total weight of the polyurethane composition. For example, in an exemplary and non-limiting embodiment, a polyurethane can comprise from about 100 to about 200 parts by weight filler, including, for example, 110, 120, 130, 140, 150, 160, 170, 180, and 190 parts by weight filler, relative to the total weight of the polyurethane.

In one aspect, the padded backing layer portion can provide improved dimensional stability (i.e., the ability of a material to retain its shape and size) to floor coverings under end-use conditions. A flooring underlayment lacking suitable dimensional stability tends to ripple, buckle, and can even change in size over time due to changes in temperature, humidity, high traffic, heavy rolling, and the like.

In some aspects, the padded backing layer portion can be adhered to the rigid composite core layer by any known in the art methods. In these aspects, where the first and second rigid composite core layer is present, the padded backing layer can be adhered to the bottom surface of the second composite core layer by any known in the art methods. In some aspects, the padded backing layer portion can be adhered utilizing an adhesive composition.

It is understood that the adhesive composition can be any adhesive known in the art. In some aspects, the adhesive composition comprises at least one of acrylic adhesive, ethylene-vinyl acetate (EVA), ethylene-acrylic acid (EAA), ethylene-acrylic acid-maleic anhydride (EAA-MAH), ethylene-methyl acrylate-maleic anhydride (EMA-MAH), ethylene-vinyl acetate-maleic anhydride (EVA-MAH), low density-polyethylene-maleic anhydride (LDPE-MAH), high density polyethylene-maleic anhydride (HDPE-MAH), polyurethane (PUR), polyurethane dispersions (PUD), a UV-curable adhesive, or a combination thereof. In some aspects, the polyurethane dispersions can comprise isocyanate terminated urethane polymer, methylenebis(phenylisocyanate), methylene bisphenyl isocyanate, and the like. The polyurethane dispersion can further comprise oxazolidine hardeners and various modifiers.

In some aspects, the UV-curable adhesive compositions can comprise polyurethane acrylate-based main-chain polymers, polyisoprene acrylate-based main chain polymers, polybutadiene acrylate-based main-chain polymers, monomeric (meth) acrylates, and the like. In certain aspects, the UV-curable adhesive compositions can comprise any adhesives known in the art that are capable of being cured upon exposure to a UV light. In other aspects, the UV-curable adhesive composition can further comprise other additives such as, for example, and without limitation photo-polymerization initiators, additives that increase flexibility of the resin, and the like.

In still further aspects, the adhesive composition comprises ethylene-vinyl acetate (EVA). In yet other aspects, the adhesive comprises ethylene-acrylic acid (EAA). In still further aspects, the adhesive comprises polyurethane dispersions (PUD), polyurethane reactive (PUR) hot melt adhesive.

The adhesive composition can comprise substantially linear ethylene polymers and homogeneously branched linear ethylene polymers (i.e., homogeneously branched ethylene polymers). Homogeneously branched ethylene polymers (including substantially linear ethylene polymers in particular) have low solidification temperatures, good adhesion to polypropylene, and low modulus relative to conventional ethylene polymers such as low density polyethylene (LDPE), heterogeneously branched linear low density polyethylene (LLDPE), high density polyethylene (HDPE), and heterogeneously branched ultra-low density polyethylene (ULDPE).

In certain aspects, the adhesive composition has a thickness of about 0.1 mil to about 5 mil, including exemplary values of about 0.5 mil, about 1 mil, about 1.5 mil, about 2 mil, about 2.5 mil, about 3 mil, about 3.5 mil, about 4 mil, and about 4.5 mil. In still further aspects, the adhesive can have any thickness in a range derived from any two of the above listed exemplary values. For example, the adhesive composition can comprise a thickness in a range of from about 0.5 mil to about 4 mil, or from about 0.1 mil to about 3 mil.

In yet further aspects, the bottom surface of the padded backing layer portion is configured to abut a subfloor structure when the rigid composite board floor covering is placed in a selected orientation. The padded backing layer portion is adhered to the subfloor structure by any known in the art methods. In some aspects, the any of the listed above adhesive compositions can be used to adhere the bottom surface of the padded backing layer portion to the subfloor structure. In yet other aspects, the adhesive composition used to adhere the padded backing layer portion to the subfloor structure can comprise a transitional pressure sensitive adhesive, a pressure sensitive adhesive, a polyurethane based adhesive.

In some aspects, adhesives used to adhere various layers of the rigid composite board floor covering as well as adhere the bottom surface of the padded backing layer portion to the subfloor structure can comprise a pressure sensitive adhesive that are protected with a release paper, such as a conventional peel and stick adhesive layer.

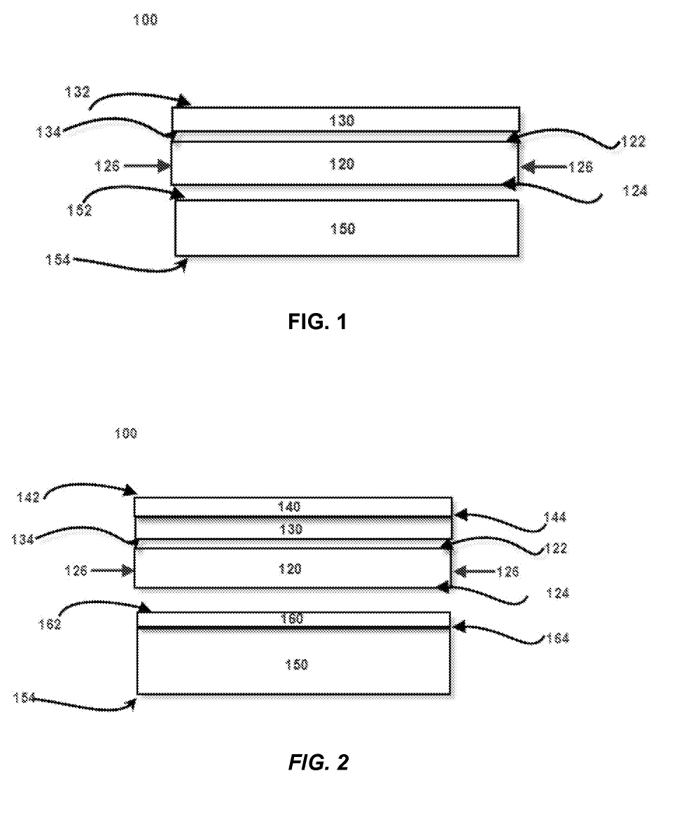

With reference to FIGS. 1 and 2, the various components of exemplary rigid composite floor board of the present disclosure are shown. FIG. 1, illustrates an exemplary rigid composite board floor covering 100. The rigid composite board floor covering 100 comprises a rigid composite core layer 120 having a top surface 122 and a bottom surface 124, wherein edges 126 do not define any form of interlocking profile or mating mechanism and are configured to simply abut one another in an end use installation. A decorative layer portion 130 has a top surface 132 and a bottom surface 134, wherein the bottom surface 134 of the decorative layer portion overlays the top surface 122 of the rigid composite core layer. As further illustrated in FIG. 2, the decorative layer portion further comprises an optional wear layer 140 having a top surface 142 and a bottom surface 144. In such aspects, the tops surface of the wear layer is the top surface of the decorative layer portion.

A padded backing layer portion 150 has a top surface 152 and a bottom surface 154, wherein the top surface of the padded backing layer portion is attached to the bottom surface of the rigid composite core layer (FIG. 1). As further illustrated in FIG. 2, the padded backing layer portion 150 can comprise optional layers such as a balancing layer 160 having a top surface 162 and a bottom surface 164 (FIG. 2). In such aspects, the top surface of the balancing layer is the top surface of the padded backing layer and it is attached to the bottom surface of the rigid composite core layer.

In some aspects, the inventive flooring covering can comprise a first and a second rigid composite layer, wherein an additional acoustical layer is sandwiched between the first and the second rigid composite layer. In such aspects, the acoustical layer has a top and a bottom surfaces. In certain aspects, the top surface of the acoustical layer can be adhered to the bottom layer of the first rigid composite core layer and the bottom surface of the acoustical layer can be attached to the top surface of the second rigid composite core layer. In these aspects, the bottom surface of the second rigid composite core layer is configured to abut a subfloor structure when the rigid composite floor covering is placed in a selected orientation. It is understood that in the aspects, where acoustical layer sandwiched between the first and the second rigid composite core layers is present such layer can comprise any compositions described for a padded backing layer portion. In fact, the padded backing layer portion and the acoustical layer can be the same. In yet other aspects, an additional padded backing layer portion comprising a top and a bottom surfaces can be present. In these aspects, the top surface of the padded backing layer portion is adhered to the bottom surface of the second rigid composite core layer. In further aspects, the bottom surface of the padded backing layer portion is configured to abut a subfloor structure when the rigid composite floor covering is placed in a selected orientation.

In some aspects, the inventive padded backing layer portion provides improved acoustical properties. Acoustical properties of the rigid composite board floor covering comprising an inventive padded backing layer portion were tested on exemplary floor covering over a 6 inch concrete slab. The acoustical properties were tested in accordance with the ASTM E492-09 test, titled “Standard Test Method for Laboratory Measurement of Impact Sound Transmission Through Floor-Ceiling Assemblies Using the Tapping Machine,” and classified in accordance with ASTM E989-06, entitled, “Standard Classification for Determination of Impact Insulation Class (IIC)”. This method measures the impact sound transmission performance of a floor/ceiling assembly, in a controlled laboratory environment. In some aspects, the rigid composite board floor coverings described herein can provide an IIC rating to a level of 51 or greater, 55 or greater, 60 or greater, 65 or greater, 70 or greater, 75 or greater, or 85 or greater. It is understood that the inventive floor covering having IIC rating higher than 51 can substantially reduce impact sound transmissions to lower levels, and thus substantially reducing or even substantially eliminating the bothersome noises.

In still further aspects, the acoustical advantages of the presently described floor coverings can be characterized by an IIC value that is a relative percentage improvement when compared to a reference analysis. This relative improvement can in one aspect be relative to a substantially identical reference floor covering in the absence of the attached pad when both are analyzed pursuant to the testing standards identified above. In another aspect, this relative improvement can be relative to the testing protocols identified above in the absence of any floor covering present. For example, in one aspect, the inventive floor coverings disclosed herein can exhibit an IIC value that is at least 5% higher than a comparative reference analysis. In still further aspects, the relative improvement can be at least 10%, 15%, 20%, 25%, 30%, or even greater.

### Floor Covering Installations

In use, the disclosed rigid composite floor covering boards can be installed to provide a rigid composite board floor covering installation. Such rigid composite board flooring installations comprise a plurality of adjacent rigid composite boards as disclosed herein in a selected orientation overlying a subfloor structure. Each of the plurality of adjacent rigid composite boards comprises a rigid composite core layer having a top surface and an opposed bottom surface and a plurality of side edges extending between the opposed top and bottom surfaces. In some aspects, the each of the plurality of adjacent rigid composite boards can comprise a first and a second rigid composite core layer having a top surface and an opposed bottom surface and a plurality of side edges extending between the opposed top and bottom surfaces. The plurality of side edges do not define any form of an interlocking or other mating attachment mechanism such as a conventional tongue and groove or click lock feature. A decorative layer portion having a top surface and an opposing bottom surface overlies the rigid composite core layer such that the top surface of the rigid composite core layer contacts the bottom surface of the decorative layer portion. A padded backing layer portion having a top surface and an opposed bottom surface is attached to the bottom surface of the rigid composite core layer. The bottom surface of each padded backing layer portion of each of the plurality of adjacent rigid composite boards is adhered to the subfloor structure as a direct glue installation in contrast to a floating floor type installation.

In the aspects, where the first and the second rigid composite core layers are present, an additional acoustical layer can be positioned between the first and the second rigid composite core layer. In certain aspects, the acoustical layer can be the same as the padded backing layer portion and to have a top and a bottom surface. In yet other aspects, the top surface of the acoustical layer can be attached to the bottom surface of the first rigid composite core layer, where the bottom surface of the acoustical layer can be attached to the top surface of the second rigid composite core layer. In such aspects, the bottom surface of the second rigid composite core layer is adhered to the subfloor structure as a direct glue installation in contrast to a floating floor type installation. In some optional aspects, an additional padded backing layer portion can be adhered to the bottom surface of the second rigid composite core layer. In such aspects, a bottom surface of the padded backing layer portion is adhered to the subfloor structure as a direct glue installation in contrast to a floating floor type installation. It should be understood that any one of the plurality of adjacent rigid composite boards can comprise any of the component layers disclosed and described herein.

### Methods

In further aspects, the present disclosure provides a method of making the rigid composite board floor coverings disclosed herein. The method generally comprises providing a rigid composite core layer as described herein, having a top surface and an opposed bottom surface and a plurality of side edges extending between the opposed top and bottom surfaces, wherein the plurality of side edges do not define any form of an interlocking mechanism. In yet other aspects, the method can comprise providing a first and a second composite core layer as described herein, each having a top surface and an opposed bottom surface and a plurality of side edges extending between the opposed top and bottom surfaces, wherein the plurality of side edges do not define any form of an interlocking mechanism. A decorative layer portion as described herein is bonded to the top surface of the rigid composite core layer and a padded backing layer portion as described herein is bonded to the bottom surface of the rigid composite core layer. In yet other aspects, an acoustical layer as described herein can be sandwiched between the first and second rigid composite core layers. In certain aspects, where the acoustical layer is present, an additional padded backing layer can be adhered to the bottom surface of the second rigid composite core layer.

The provided rigid composite core layer can be any form of rigid composite core layer previously described herein. It is further understood that if the first and the second rigid composite core layer is present, the first and the second rigid composite core layer can be the same or different. In further aspects, the step of providing can comprise that manufacture of such rigid composite core layer. To that end, it should be understood that the rigid composite core layer can be manufactured by any processes known in the art, including for example, calendaring, extrusion, or under heat and pressure on a conventional double belted press.

In some aspects, the rigid composite core layer can be manufactured or otherwise precut to have any predetermined size and shape prior to assembly with the decorative layer portion and the padded backing portion. For example, the predetermined size of the rigid composite core layer can be in the range of from about 3 inches to about 48 inches wide and in the range of from about 12 inches to about 96 inch long. Based upon the desired combination of widths and lengths, the rigid composite boards of the disclosure can be configured as tiles, planks, or even relatively large sheets of material suitable for use as wall or ceiling boards.

In yet other aspects, the rigid composite core layer can have a width in the range from about 3 inches to about 48 inches, including exemplary widths of about 5 inches, about 8 inches, about 10 inches, about 13 inches, about 15 inches, about 18 inches, about 20 inches, about 23 inches, about 25 inches, about 28 inches, about 30 inches, about 33 inches, about 35 inches, about 36 inches, about 38 inches, about 40 inches, about 43 inches, and about 45 inches. In still further aspects, the rigid composite core layer can have a width in a range derived by any of the above exemplified widths.

The rigid composite core layer can have any desired length. For example, the length can be in the range from about 12 inches to about 100 inches, including exemplary values of about 15 inches, about 20 inches, about 25 inches, about 30 inches, about 35 inches, about 40 inches, about 45 inches, about 50 inches, about 55 inches, about 60 inches, about 65 inches, about 70 inches, about 75 inches, about 80 inches, about 85 inches, about 90 inches, and about 96 inches. In still further aspects, the rigid composite core layer can have a length within any range derived by any of the above described lengths.

The rigid composite core layer can also have any desired thickness, including for example, a thickness in the range from about 1.5 mm to about 12 mm. Exemplary thickness can also include about 2 mm, about 3 mm, about 4 mm, about 5 mm, about 6 mm, about 7 mm, about 8 mm, about 9 mm, about 10 mm, and about 11 mm. In still further aspects, the rigid composite core layer can have a thickness within any range derived from any two of the above thicknesses.

The decorative layer portion as described herein is bonded to the top surface of the rigid composite core layer. In some aspects, the bonding is performed using an adhesive composition. In yet other aspects, the bonding is performed using heat and pressure. In other aspects, the bonding is performed by laminating techniques. It should be understood that in those aspects where the decorative layer portion comprises a plurality of two or more layer or components, in one aspect the entire composite decorative layer portion can first be provided and then bonded to the top surface of the rigid composite core layer or, alternatively, each layer can be sequentially applied to the rigid composite core layer.

The padded backing layer portion as described herein (and any individual layers thereof in those aspects having more than one layer) is adhered to the bottom surface of the rigid composite core layer utilizing any bonding techniques known in the art and disclosed herein. In one aspect, the padded backing portion can be bonded using heat and pressure. In other aspects, the bonding is performed by laminating techniques. In other aspects, the padded backing layer portion can be bonded via heat bonding, utilizing various adhesive compositions, or using a cold or hot press. In still further aspects, the padded backing layer portion can be a foam formed in situ on the bottom surface of the rigid composite core layer. It should be understood that in those aspects where the padded backing layer portion comprises a plurality of two or more layers or components, in one aspect the entire composite padded backing layer portion can first be provided and then bonded to the top bottom surface of the rigid composite core layer or, alternatively, each layer can be sequentially applied to the bottom surface of the rigid composite core layer until the desired composite multilayer padded backing layer portion is complete. It is also understood that if the first and the second rigid composite core layers are present, the acoustic layer that can be the same composition as the padded backing layer portion described herein can be adhered to the bottom surface of the first rigid composite core layer and to the top surface of the second rigid composite core layer by any methods described herein. In yet other aspects, the padded backing layer portion can be adhered to the bottom surface of the second rigid composite core layer by any methods described herein.

The padded backing layer portion and the decorative layer portion can be applied to the respect top and bottom surfaces of the rigid composite core layer in any desired order or even simultaneously.

It is further understood that all components of the rigid composite board floor covering are precut to the same predetermined size and shape prior to the bonding. It is further understood that the rigid composite core layer is not cut to a second predetermined size and shape after the bonding of the decorative layer portion and padded backing layer portion to the respective top and bottom surface thereof occurred.

In some aspects, the rigid composite core layer is provided in a desired predetermined size and shape prior to assembly with the selected decorative portion layer and padded backing portion layer. In these aspects, the respective decorative portion layer and padded backing portion layer can similarly be sized and shaped to correspond with the size and shape of the rigid composite core layer. These aspects provide the added advantage of eliminating any need for subsequent cutting or resizing of the finished rigid composite core board flooring. However, it should be understood that in other aspects, the method can further comprise the step of subsequently cutting the rigid composite board after manufacture to a further desired size and shape.

In still further aspects, disclosed is a method of forming a rigid composite board floor covering installation, comprising: providing a plurality of rigid composite boards, wherein each of the plurality of rigid composite boards comprises: a rigid composite core layer having a top surface and an opposed bottom surface and a plurality of side edges extending between the opposed top and bottom surfaces, wherein the plurality of side edges do not define a tongue and groove structure; a decorative layer portion having a top surface and an opposing bottom surface, wherein the decorative layer portion overlies the rigid composite core layer such that the top surface of the rigid composite core layer contacts the bottom surface of the decorative layer portion; and a padded backing layer portion having a top surface and an opposed bottom surface, wherein the top surface of the padded backing layer portion is attached to the bottom surface of the rigid composite core layer; and adhering the bottom surface of each padded backing layer to a surface of a subfloor structure to form a selected arrangement of adjacent rigid composite boards, wherein adjacent rigid composite boards are not connected by a tongue and groove structure; and wherein any surface irregularity present on the subfloor structure is not telegraphed to the decorative layer portion of the rigid composite board overlying said irregularity.

In still further aspects, a method of forming a rigid composite board floor covering installation, comprising: providing a plurality of rigid composite boards, wherein each of the plurality of rigid composite boards comprises: a first and a second rigid composite core layer, each having a top surface and an opposed bottom surface and a plurality of side edges extending between the opposed top and bottom surfaces, wherein the plurality of side edges do not define a tongue and groove structure; a decorative layer portion having a top surface and an opposing bottom surface, wherein the decorative portion layer overlies the first rigid composite core layer such that the top surface of the first rigid composite core layer contacts the bottom surface of the decorative portion layer; and an acoustical layer having a top surface and an opposed bottom surface, wherein the top surface of the acoustical layer is attached to the bottom surface of the first rigid composite core layer; and the bottom surface of the acoustical layer is attached to the top surface of the second rigid composite core layer. In some aspects, the bottom surface of each second rigid composite core layer can be adhered to a top surface of the padded backing layer portion. In yet other aspects, the bottom surface of each padded backing layer can be adhered to a surface of a subfloor structure to form a selected arrangement of adjacent rigid composite boards, and wherein adjacent rigid composite boards are not connected by a tongue and groove structure.

In alternative embodiments it is understood that any of the disclosed layer can be present in any amount. In some aspects, at least one of each of the disclosed layers is present. In yet other aspects, at least two of the rigid composite core layers are present. In still further aspects, at least two of the decorative layer portions are present. In yet other aspects, at least two of the padded backing layer portions are present. In still further aspects, at least two of each of the disclosed layers are present. It is understood that a number of layer is not limited and can be defined by one of ordinary skill in the art to achieve a desirable result. In yet alternative aspects, a plurality of rigid composite core layer can be present. In such aspects, an acoustical layer can be sandwiched between two of the plurality of rigid composite core layers. It is further understood that in such aspects, the acoustical layer can be the same as the padded backing layer described herein. In yet other aspects, wherein the plurality of rigid composite core layers and the acoustical layer sandwiched there between is present, an optional padded backing layer can be present.

The rigid composite board flooring of the present disclosure exhibits several advantageous features. As one of ordinary skill in the art would readily appreciate, the inventive flooring allows more efficient manufacture of each layer. For example, rigid composite core layers do not require acclimation periods to normalize or equalize stress after manufacture. Further, all subsequent layers can be applied during the manufacturing process without the need to endure any additional acclimation period. An additional benefit of the inventive flooring coverings is an ability to directly apply a padded backing layer to the underside of the rigid composite core layer which eliminates the need for a separate acoustical or padded underlayment during installation. If an additional acoustical layer is desired, this layer can be also added during manufacturing process minimizing an installation time and eliminating unnecessary steps.

Further, since no acclimation needed during manufacturing process, a more efficient and economically beneficial installation can be easily achieved. The inventive rigid composite board flooring can also be directly glued down to the subfloor without a need to provide any interlocking mechanisms. Still further, it has been discovered that the inventive flooring allows to achieve desired IIC values and further minimize or even eliminate the hollow sounds that are often associated with other rigid composite board flooring and resilient flooring, such as, for example Luxury Vinyl Tiles (LVT) flooring.

What is claimed is:

1. A rigid composite board floor covering, comprising:
a rigid composite core layer having a top surface and an opposed bottom surface and a plurality of side edges extending between the opposed top and bottom surfaces, wherein the plurality of side edges do not define an edge locking structure;
a decorative portion having a top surface and an opposing bottom surface, wherein the decorative portion overlies the rigid composite core layer such that the top surface of the rigid composite core layer contacts the bottom surface of the decorative portion; and
a padded backing layer portion having a top surface and an opposed bottom surface, wherein the top surface of the padded backing layer portion is attached to the bottom surface of the rigid composite core layer,
wherein the bottom surface of the padded backing layer portion is configured to abut a subfloor structure when the rigid composite floor covering is placed in a selected orientation.

2. The rigid composite board floor covering of claim 1, wherein the rigid composite core layer is a rigid wood plastic composite (WPC) core layer.

3. The rigid composite board floor covering of claim 1, wherein the decorative portion comprises a vinyl layer.

4. The rigid composite board floor covering of claim 1, wherein the decorative portion comprises a printed film layer and a wear layer.

5. The rigid composite board floor covering of claim 1, wherein the decorative portion comprises a direct printed image.

6. The rigid composite board floor covering of claim 1, wherein the decorative portion comprises a luxury vinyl tile (LVT) comprising a wear layer, an image layer, at least one core layer, and a balancing layer.

7. The rigid composite board floor covering of claim 1, wherein the decorative portion comprises a wood veneer

8. The rigid composite board floor covering of claim 1, wherein the rigid composite core layer is a rigid composite core layer comprising a composition comprising a thermoplastic resin and a filler.

9. The rigid composite board floor covering of claim 8, wherein the thermoplastic resin comprises a polyvinyl chloride.

10. The rigid composite board floor covering of claim 8, wherein the filler comprises calcium carbonate.

11. The rigid composite board floor covering of claim 8, wherein the composition further comprises a stabilizer.

12. The rigid composite board floor covering of claim 1, wherein the padded backing layer portion comprises a polyurethane foam composition.

13. The rigid composite board floor covering of claim 1, wherein the padded backing layer portion does not comprise a rubber component.

14. The rigid composite board floor covering of claim 1, wherein the padded backing layer comprises a cork layer.

15. The rigid composite board floor covering of claim 1, wherein the padded backing layer comprises ethylene vinyl acetate.

16. The rigid composite board floor covering of claim 1, wherein the padded backing layer comprises irradiation crosslinked polyethylene.

17. The rigid composite board floor covering of claim 1, wherein the padded backing layer comprises a non woven polyethylene terephthalate (PET) mat.

18. The rigid composite board floor covering of claim 1, wherein the rigid composite board floor covering exhibits an IIC rating of 51 of greater.

19. The rigid composite board floor covering of claim 1, wherein the rigid composite core layer at least substantially prevents telegraphing of subfloor structure irregularities to the decorative layer portion when the rigid composite floor covering is abutting the subfloor structure in the selected orientation

20. The rigid composite board floor covering of claim 1, wherein the composite floor covering exhibits an IIC rating that is at least 5 percent higher than that of a reference floor covering in the absence of the attached pad.

21. The rigid composite board floor covering of claim 1, wherein the composite floor covering exhibits an IIC rating that is at least 10 percent higher than that of a substantially identical reference floor covering in the absence of the attached pad.

22. The rigid composite board floor covering of claim 1, wherein a first side edge of the plurality of side edges extending between the opposed top and bottom surfaces defines a tongue structure and an second side edge opposing the first side edge defines a groove structure.

23. A method of making a rigid composite board floor covering; comprising the steps:
providing a rigid composite core layer of a predetermined size and shape having a top surface and an opposed bottom surface and a plurality of side edges extending between the opposed top and bottom surfaces, wherein the plurality of side edges do not define a side edge locking structure; and
applying a decorative portion to the top surface of the rigid composite core layer; and
bonding a padded backing layer portion to the bottom surface of the rigid composite core layer;
wherein after the applying of the decorative portion and padded backing layer portion to the rigid composite core layer an acclimation period is not required to equalize component stress.

24. The method of claim 23, wherein the rigid composite core layer is not cut to a second predetermined size and shape after applying of the decorative portion and padded backing layer portion to the respective top and bottom surfaces thereof occurred.

25. A rigid composite board floor covering, comprising:
a first and a second rigid composite core layer, each having a top surface and an opposed bottom surface and a plurality of side edges extending between the opposed top and bottom surfaces, wherein the plurality of side edges do not define a side edge locking structure;
a decorative portion having a top surface and an opposing bottom surface, wherein the decorative portion overlies the first rigid composite core layer such that the top surface of the first rigid composite core layer contacts the bottom surface of the decorative portion; and
an acoustical layer having a top surface and an opposed bottom surface, wherein the top surface of the acoustical layer is attached to the bottom surface of the first rigid composite core layer, and wherein the bottom surface of the acoustical layer is attached to the top surface of the second rigid composite core layer.

26. The rigid composite board floor covering of claim 26, wherein the bottom surface of the second rigid composite core layer is configured to about a subfloor structure when the rigid composite floor covering is placed in a selected orientation.

27. The rigid composite board floor covering of claim 26, wherein the bottom surface of the second rigid composite core layer is adhered to a top surface of a padded backing layer portion.

28. The rigid composite board floor covering of claim 26, wherein a first side edge of the plurality of side edges extending between the opposed top and bottom surfaces defines a tongue structure and an second side edge opposing the first side edge defines a groove structure.

29. A method of making a rigid composite board floor covering; comprising the steps:
providing a first and a second rigid composite core layer of a predetermined size and shape, each having a top surface and an opposed bottom surface and a plurality of side edges extending between the opposed top and bottom surfaces, wherein the plurality of side edges do not define a side edge locking structure; and
applying a decorative portion to the top surface of the first rigid composite core layer; and
bonding a top surface of an acoustical layer to the bottom surface of the first rigid composite core layer;
bonding a bottom surface of the acoustical layer to the top surface of the second rigid composite layer,
wherein after the applying of the decorative layer portion and acoustical layer to the first and the second rigid composite core layer an acclimation period is not required to equalize component stress.

30. The method of claim 29, wherein the bottom surface of the second rigid core layer is adhered to a top surface of a padded backing layer portion.
